(19) United States
(12) Patent Application Publication
(10) Pub. No.: US 2022/0009167 A1
(43) Pub. Date: Jan. 13, 2022

(54) OPTICAL SYSTEM FOR OPTICAL SHAPING APPARATUS

(71) Applicant: KANTATSU CO., LTD., Tokyo (JP)

(72) Inventors: Eiji OSHIMA, Tokyo (JP); Hisanori SUZUKI, Tokyo (JP)

(21) Appl. No.: 17/186,753

(22) Filed: Feb. 26, 2021

(30) Foreign Application Priority Data
Apr. 14, 2020 (JP) 2020-072397

(51) Int. Cl. B29C 64/268; G02B 19/00; G02B 27/09; B33Y 30/00

(52) U.S. Cl. CPC B29C 64/268; G02B 19/0009; B29C 64/124; G02B 19/0047; B33Y 30/00; G02B 27/0955

(57) ABSTRACT

The present invention provides an optical system for stereolithography apparatus that enables highly accurate manufacturing by a stereolithography apparatus. An optical system 10 for stereolithography apparatus, includes: a light source 11; an optical scanning section 16 configured to reflect light emitted from the light source 11 to scan to a manufacturing surface IM; and a condenser lens 17 arranged between the optical scanning section 16 and the manufacturing surface IM and configured to condense the light reflected by the optical scanning section 16. When the condenser lens 17 has a focal length f and the condenser lens 17 has a normal angle A at a maximum effective diameter on a surface on a side of the manufacturing surface IM, the optical system 10 for stereolithography apparatus satisfies

f≤25 mm,

0.3<cos(A).

### BACKGROUND OF THE INVENTION

### 1. Field of the Invention

The present invention relates to an optical system for stereolithography apparatus preferably mounted on stereolithography apparatuses harden a photocurable resin using light emitted from a light source, such as a laser light source and an LED light source, to manufacture in a desired shape.

### 2. Description of the Related Art

For the purpose of low-volume high-variety production, reduction in the prototyping period, reduction in the development costs, and the like, the additive manufacturing technology, so-called 3D printers, receives attention. The 3D printers use three-dimensional data created by CAD and the like as a design plan and join materials based on a cross-sectional shape thereof to manufacture a three-dimensional object. Manufacturing processes of the 3D printers include various processes. Among all, vat photopolymerization (stereolithography) to selectively solidify a photocurable resin with light, such as laser, for manufacturing enables fine and high resolution manufacturing.

As a 3D printer employing the stereolithographic process, there is, for example, a stereolithography apparatus described in JP 2017-94563 A. The optical system mounted on the stereolithography apparatus has a light source, an optical intensity modulator, a beam expander, a condenser lens, and two galvanometer mirrors. Light emitted from the light source passes through the optical intensity modulator, the beam expander, and the condenser lens in order to be incident on the galvanometer mirrors. Each galvanometer mirror is provided with a mirror and an actuator, and the respective mirrors rotate in the directions orthogonal to each other. The light reflected in order by respective mirrors of the galvanometer mirrors is radiated over the photocurable resin on the manufacturing surface and the area irradiated with the light is hardened. Lamination of layers thus hardened allows manufacturing of a three-dimensional object.

### SUMMARY

In recent years, with an increase in materials to be manufactured by the stereolithographic process, manufacturing with higher resolution than before is expected. For example, to faithfully reproduce a concavo-convex structure in a diffractive optical element (DOE), the resolution of the manufacturing has to be higher than before. Although stereolithography enables manufacturing with higher resolution by reducing the condensation diameter, the so-called spot diameter, of the light beam radiated on the manufacturing surface, there are various technical tasks to achieve it.

In the optical system of the stereolithography apparatus described in JP 2017-94563 A, the light beam emitted from the light source is expanded by the beam expander and the light beam thus expanded is incident on the condenser lens. Since the increase in the beam diameter of the light beam causes an increase in the numerical aperture (NA) of the condenser lens, it is possible to reduce the spot diameter of the light beam radiated on the manufacturing surface. However, the galvanometer mirrors to scan with the light beam are arranged between the condenser lens and the manufacturing surface, and thus the distance from the condenser lens to the manufacturing surface consequently turns out to be long. Accordingly, in the optical system described in JP 2017-94563 A, it is difficult to further reduce the spot diameter of the light beam radiated on the manufacturing surface and there is a limit to the improvement in manufacturing accuracy.

It is an object of the present invention to provide an optical system for stereolithography apparatus enabling stereolithography with high resolution.

To achieve the above object, an optical system for stereolithography apparatus of the present invention includes: a light source; an optical scanning section configured to reflect light emitted from the light source to scan to a manufacturing surface; and a condenser lens arranged between the optical scanning section and the manufacturing surface and configured to condense the light reflected by the optical scanning section. In such a configuration, the optical system for stereolithography apparatus of the present invention satisfies the following conditional expressions (1) and (2) when the condenser lens has a focal length f and the condenser lens has a normal angle A at a maximum effective diameter on a surface on a side of the manufacturing surface:

f≤25 mm (1);

0.3<cos(A) (2).

In the optical system for stereolithography apparatus in the past, the focal length of the condenser lens is long and it is thus difficult to reduce the spot diameter of the light beam radiated on the manufacturing surface. In contrast, in the optical system for stereolithography apparatus according to the present invention, the condenser lens is arranged between the optical scanning section and the manufacturing surface. It is thus possible to bring the condenser lens closer to the manufacturing surface, and this allows reduction in the focal length of the condenser lens. It is also possible to reduce the NA of the condenser lens, and thus the spot diameter of the light beam radiated on the manufacturing surface can be, for example, 10 μm or less by satisfying the above conditional expression (1). Therefore, the optical system for stereolithography apparatus according to the present invention enables high resolution manufacturing using stereolithography apparatuses.

There is however a concern that high resolution manufacturing may not be achieved depending on the state of light irradiation energy distribution on the manufacturing surface even when the spot diameter of the light beam radiated on the manufacturing surface can be reduced because such a stereolithography apparatus irradiates a photocurable resin with light to harden that portion for manufacturing. The resolving power of the manufactured object differs from a low light irradiation energy area to a high energy area. Due to the lens properties in general, a higher image height on the manufacturing surface causes a tendency to decrease the relative illumination. If the light irradiation energy does not reach the amount of energy to harden the photocurable resin, the manufactured object has an indistinct outline and thus high resolution manufacturing becomes difficult.

The optical system for stereolithography apparatus according to the present invention is configured to inhibit such a decrease in the relative illumination of the light beam radiated on the manufacturing surface by satisfying the above conditional expression (2). This allows homogenization of the light irradiation energy distribution on the manufacturing surface and thus enables manufacturing with higher resolution. It should be noted that the normal angle herein means an angle between a direction orthogonal to the optical axis of the condenser lens and the normal direction of the lens surface.

In the optical system for stereolithography apparatus configured as above, it is desirable that the condenser lens is a biconvex lens, and, when the condenser lens has a radius of curvature R1 on a surface on a side of the optical scanning section and the condenser lens and has a radius of curvature R2 on the surface on the side of the manufacturing surface, the optical system satisfies the following conditional expression (3):

1.0≤|R1/R2| (3).

By satisfying the conditional expression (3), the narrowing of the maximum normal angle is suppressed on the surface on the manufacturing surface side of the condenser lens to preferably inhibit the decrease in the relative illumination on the manufacturing surface.

In the optical system for stereolithography apparatus configured as above, it is desirable that the optical system further includes a beam shaping unit arranged between the light source and the optical scanning section. In this case, it is desirable that, when a light beam incident from the light source has a shorter axis on a cross section with a length Da and has a longer axis with a length Db, the beam shaping unit diffuses the light in a direction of the shorter axis to satisfy, on an emission side, the following conditional expression (4):

0.9<Da/Db<1.2 (4).

The light beam emitted from the light source often has a non-circular cross-sectional shape. In particular, semiconductor lasers structurally have a rectangular light emission surface and thus emit a light beam with an elliptical cross-sectional shape. When the light beam in an elliptical shape is incident on the condenser lens, the light beam radiated on the manufacturing surface also has an elliptical spot shape, causing a decrease in manufacturing efficiency. In the case of the elliptical spot shape, it is difficult to reduce the spot diameter and thus to perform manufacturing with high resolution. By satisfying the above conditional expression (4), the light beam emitted from the light source is shaped in a substantially circular shape by the beam shaping unit to enable high resolution manufacturing.

In the optical system for stereolithography apparatus configured as above, it is desirable that the optical scanning section is provided with a reflective mirror and the light beam emitted from the beam shaping unit has a diameter equal to the diameter of the reflective mirror. The light beam reflected by reflective mirror is condensed on the manufacturing surface by the condenser lens. Since the diameter of the light beam incident on the optical scanning section is equal to the diameter of the reflective mirror, the intervals and the size of light spots continuously radiated on the manufacturing surface are appropriately kept by scanning by the optical scanning section to enable manufacturing with higher resolution.

It is desirable that the beam shaping unit has a concave surface formed along the longer axis on an incident side of the light beam emitted from the light source and also has a convex surface formed along the longer axis on the emission side.

According to such a configuration, the light on the shorter axis side of the light beam incident on the beam shaping unit is expanded by the concave surface and condensed on the emission side by the convex surface. It is thus possible to emit the light incident in an elliptical shape on the beam shaping unit as parallel light in a substantially circular shape.

The optical system for stereolithography apparatus of the present invention enables high resolution manufacturing with stereolithography apparatuses.

### BRIEF DESCRIPTION OF THE DRAWINGS

FIG. 1 is a schematic diagram of a stereolithography apparatus having an optical system for stereolithography apparatus according to an embodiment mounted thereon.

FIG. 2 is an optical path diagram illustrating schematic configuration of an optical system for stereolithography apparatus according to Numerical Example 1.

FIG. 3 is a cross-sectional view taken along the longer axis of the incident light in the shaping unit.

FIG. 4 is a cross-sectional view taken along the shorter axis of the incident light in the shaping unit.

FIG. 5 is a diagram illustrating the normal angle.

FIG. 6 is an optical path diagram illustrating schematic configuration of an optical system for stereolithography apparatus according to Numerical Example 2.

FIG. 7 is an optical path diagram illustrating schematic configuration of an optical system for stereolithography apparatus according to Numerical Example 3.

FIG. 8 is an optical path diagram illustrating schematic configuration of an optical system for stereolithography apparatus according to Numerical Example 4.

### DETAILED DESCRIPTION OF THE PREFERRED EMBODIMENTS

An embodiment of the present invention is described below in detail with reference to the drawings.

The optical system for stereolithography apparatus according to the present embodiment is assumed to be mounted on a stereolithography apparatus employing the vat photopolymerization (stereolithographic) process to selectively solidify a photocurable resin with light, such as laser, for manufacturing.

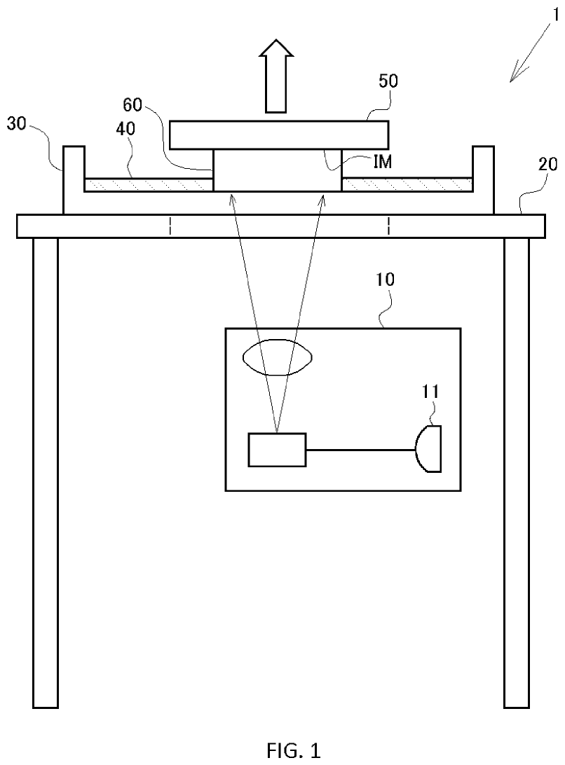

Firstly, the schematic configuration of the stereolithography apparatus is described. As illustrated in FIG. 1, a stereolithography apparatus 1 has an optical system 10 for stereolithography apparatus, a stage 20, a vat 30 placed on the stage 20, a photocurable resin 40 retained in the vat 30, a platform 50 arranged above the vat 30. In the stage 20, an opening in approximately the same size as a manufacturing surface IM of the platform 50 in a position facing the manufacturing surface IM across a bottom surface of the vat 30. The optical system 10 for stereolithography apparatus is arranged below the opening in the stage 20.

On manufacturing, the platform 50 is immersed in the photocurable resin 40 in the vat 30. A light beam emitted from a light source 11 of the optical system 10 for stereolithography apparatus scans the manufacturing surface IM of the platform 50 and the area irradiated with the light is hardened on the manufacturing surface IM. Further, by continuously lifting the platform 50 at a predetermined pitch, the hardened layer is laminated to form a three-dimensional manufactured object 60. At this point, the state of hardening of the photocurable resin 40 depends on the spot diameter of the radiated light, the intensity of the light energy and the state of distribution thereof, and the like. The shape and the like of the light beam emitted from the optical system 10 for stereolithography apparatus determine the accuracy of manufacturing in the stereolithography apparatus 1.

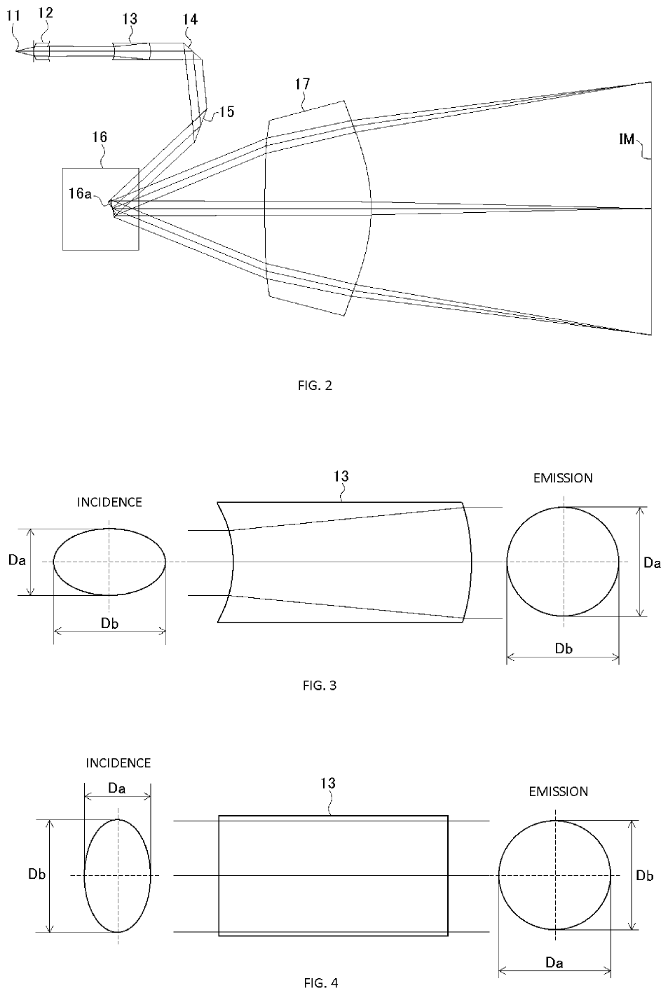

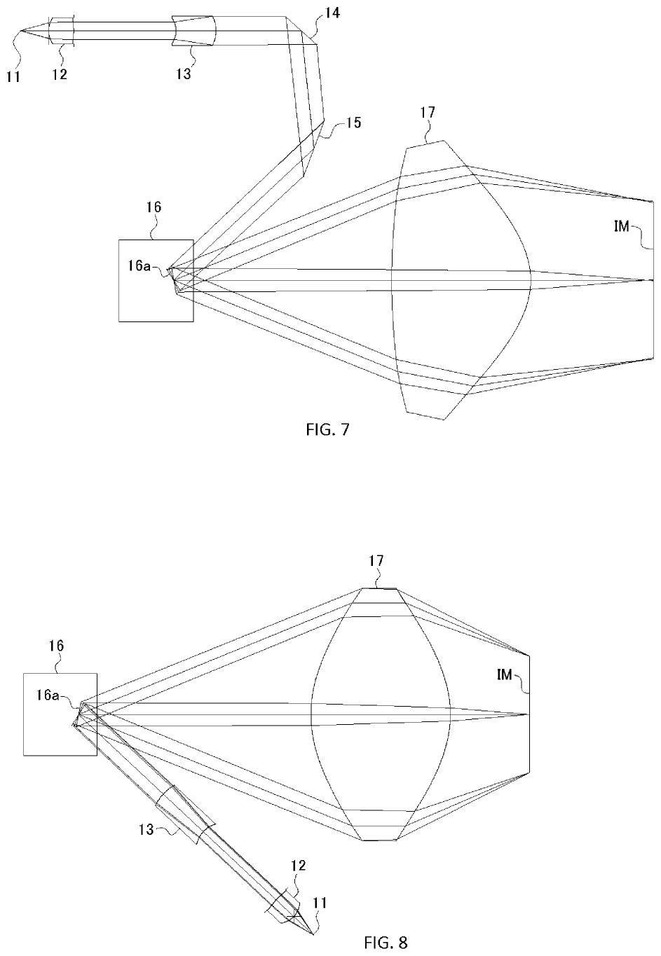

FIGS. 2 and 6 through 8 are optical path diagrams illustrating schematic configuration of optical systems for stereolithography apparatus according to Numerical Examples 1 through 4 in the present embodiment. Since all Numerical Examples have identical basic configuration, the optical system for stereolithography apparatus according to the present embodiment is described here with reference to the optical path diagram in Numerical Example 1.

As illustrated in FIG. 2, the optical system 10 for stereolithography apparatus according to the present embodiment is configured to include, from the light source 11 to the manufacturing surface IM side in order, a collimator lens 12, a beam shaping unit 13, a first dielectric mirror 14, a second dielectric mirror 15, an optical scanning section 16, and a condenser lens 17.

While various light sources are appliable as the light source 11, it is desirable to use a semiconductor light source, such as laser light sources and LED light sources, with high light emission efficiency. Among all, laser light sources have good monochromaticity and directivity and allow an increase in energy density by condensation by a lens. In the present embodiment, as the light source 11, a laser light source with a wavelength of 405 nm is used that is distributed in large quantities on the market and highly reliable. The collimator lens 12 transforms the light incident from the light source 11 into parallel light to be emitted to the beam shaping unit 13.

As illustrated in FIGS. 3 and 4, the beam shaping unit 13 in the present embodiment has a shape of joining a planoconcave cylindrical lens and a planoconvex cylindrical lens on the respective flat surface sides to have the same direction of forming the convex surface and the concave surface. It should be noted that the beam shaping unit 13 may be configured from two concave and convex cylindrical lenses.

Since the laser light source is used as the light source 11 in the present embodiment, substantially elliptical parallel light is emitted from the collimator lens 12. The beam shaping unit 13 shapes the substantially elliptical light incident from the collimator lens 12 in a substantially circular shape. To describe in detail, when an incident light beam has a shorter axis on a cross section with a length Da and has a longer axis with a length Db, the beam shaping unit 13 diffuses the light in a direction of the shorter axis to satisfy, on an emission side, the following conditional expression

0.9<Da/Db<1.2.

It should be noted that half widths are used as the values of Da and Db in the present embodiment.

The beam shaping unit 13 is described more in detail. From the beam shaping unit 13, a light beam satisfying the conditional expression “0.9<Da/Db<1.2” is emitted. For example, when a light beam input to the beam shaping unit 13 has a shorter axis on a cross section with a length Da=0.47 mm and has a longer axis with a length Db=1.01 mm, the light beam in the shorter axis direction is expanded approximately 2.13 times. As a result, the shorter axis on the emission side of the beam shaping unit 13 has a length Da=1.00 mm and the longer axis has a length Db=1.01 mm, and thus the light of “Da/Db=1.0” is to be emitted from the beam shaping unit 13.

As illustrated in FIG. 3, the beam shaping unit 13 has a surface on the incident side of the light beam (hereinafter, referred to as an “incident surface”) formed in a concave shape along the longer axis and a surface on the emission side of the light beam (hereinafter, referred to as an “emission surface”) formed in a convex shape along the longer axis. FIG. 3 illustrates a rough shape of the incident light on the incident side of the beam shaping unit 13 and a rough shape of the emission light on the emission side, respectively (same in FIG. 4). Out of the light incident on the beam shaping unit 13, the light in the shorter axis direction is diffused by the incident surface in a concave shape and also emitted as parallel light by passing through the emission surface in a convex shape.

Meanwhile, as illustrated in FIG. 4, in the beam shaping unit 13 has a cross-sectional shape in the shorter axis direction, both the incident surface and the emission surface have a radius of curvature of infinity, that is, both are flat surfaces. Out of the light incident on the beam shaping unit 13, the light in the longer axis direction is directly emitted as parallel light without being condensed or diffused.

As have been described, since the beam shaping unit 13 diffuses only the light in the shorter axis direction out of the incident light, the beam shaping unit 13 emits parallel light in a substantially circular shape.

Both the first and second dielectric mirrors 14 and 15 are flat mirrors, respectively. The light emitted from the beam shaping unit 13 is firstly reflected by the first dielectric mirror 14 and then reflected by the second dielectric mirror 15. Since the dielectric mirrors 14 and 15 are capable of folding the optical path, it is possible to miniaturize the optical system 10 for stereolithography apparatus. Either or both of the dielectric mirrors 14 and 15 may be omitted. Numerical Example 4 is an example of the configuration in which both the dielectric mirrors 14 and 15 are omitted. Omission of the dielectric mirrors 14 and 15 allows suppression of the production costs of the optical system 10 for stereolithography apparatus.

The optical scanning section 16 scans using the light beam incident from the dielectric mirror 15. The optical scanning section 16 has a two-dimensional microelectromechanical systems (MEMS) mirror 16a as a reflective mirror. The two-dimensional MEMS mirror 16a is an electromagnetically driven mirror and can move in two-dimensional directions. The light beam reflected by the two-dimensional MEMS mirror 16a scans following the movement of the two-dimensional MEMS mirror 16a.

Since the dielectric mirrors 14 and 15 described above are flat mirrors, the light incident on the optical scanning section 16 has a shape substantially identical to the shape of the light emitted from the beam shaping unit 13. In the present embodiment, high resolution manufacturing is enabled by adjusting the diameter of the light beam emitted from the beam shaping unit 13 to be substantially equal to the diameter of the MEMS mirror 16a.

For reference, a description is given to an example of the MEMS mirror 16a. When the MEMS mirror 16a has a rotation angle of ±11.1° horizontally and ±6.86° vertically, the scanning zone is horizontally 44.4° and vertically 27.44°. The driving frequency of the MEMS mirror 16a determines the resolving power of an image, which is, for example, 720 P (720 lines of effective vertical resolution).

The condenser lens 17 in the present embodiment is a biconvex lens. The condenser lens 17 satisfies each of the following conditional expressions:

f≤25 mm;

0.3<cos(A); and

1.0≤|R1/R2|,

where
f denotes the focal length of the condenser lens 17,
A denotes the normal angle at the maximum effective diameter on the surface on the manufacturing surface IM side of the condenser lens 17,
R1 denotes the radius of curvature on the surface on the optical scanning section 16 side of the condenser lens 17, and
R2 denotes the radius of curvature on the surface on the manufacturing surface IM side of the condenser lens 17.

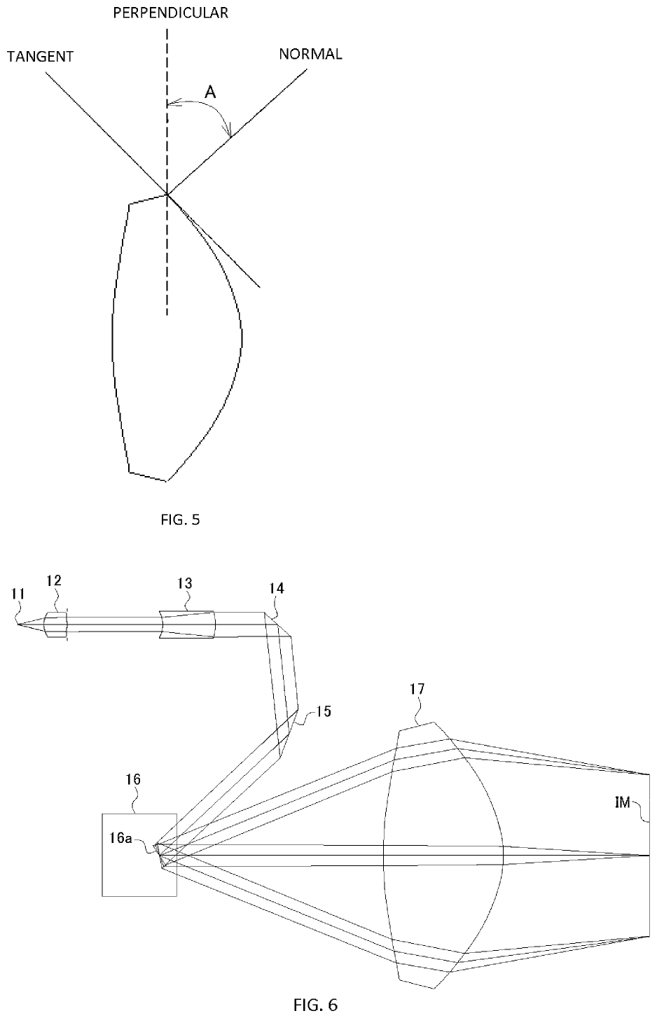

A description is given here to the normal angle. As illustrated in FIG. 5, in the present embodiment, the normal angle A is defined as an angle between the direction orthogonal to the optical axis (perpendicular) and the direction of the normal. It should be noted that the normal herein means a line vertical to the tangent of the lens surface.

In the present embodiment, the condenser lens 17 has both surfaces aspherically formed. The following expression indicates an aspherical equation of these aspherical surfaces:

$$Z = \frac{C \cdot {H}^{2}}{1 + \sqrt{1 - ( 1 + k ) \cdot {C}^{2} \cdot {H}^{2}}} + \sum ( An \cdot {H}^{n} ) \qquad [ Math 1 ]$$

where

Z denotes the length in the optical axis direction,

H denotes the length from the optical axis in the direction orthogonal to the optical axis,

C denotes the paraxial curvature (=1/r, r: paraxial radius of curvature),

k denotes the conic constant, and

An denotes the n th aspheric coefficient.

The following description gives Numerical Examples of the optical system for stereolithography apparatus according to the present embodiment. In each Numerical Example, Co denotes a collimator lens, Bs denotes a beam shaping unit, and CL denotes a condenser lens, and in each element, S1 denotes the surface on the light source side and S2 denotes the surface on the manufacturing surface IM side. In addition, in each Numerical Example, f denotes the focal length of the condenser lens, r denotes the radius of curvature, ϕ denotes the maximum effective diameter, t denotes the thickness on the optical axis, and n denotes the refractive index.

### Numerical Example 1

TABLE 1
f = 21.35 mm

| | Co-S1 | Co-S2 | Bs-S1 | Bs-S2 | CL-S1 | CL-S2 |
|---|---|---|---|---|---|---|
| r (mm) | 0.937 | −2.100 | −1.160 (y) | −1.961 (y) | 160.791 | −11.865 |
| k | −3.126E−01 | 3.816E+00 | — | — | 20.000 | −5.236 |
| A4 | 3.700E−01 | 5.104E−01 | — | — | −3.136E−04 | −3.646E−04 |
| A6 | −1.951E+00 | 5.407E−01 | — | — | 8.707E−05 | 7.319E−06 |
| A8 | 4.222E+00 | −2.670E+00 | — | — | −7.814E−06 | 6.393E−07 |
| A10 | −6.204E+00 | 3.835E+00 | — | — | 3.981E−07 | −5.412E−08 |
| A12 | 5.029E+00 | −2.649E+00 | — | — | −1.116E−08 | 1.759E−09 |
| A14 | −1.673E+00 | 9.316E−01 | — | — | 1.591E−10 | −2.593E−11 |
| A16 | — | — | — | — | −9.150E−13 | 1.417E−13 |
| ϕ (mm) | 0.6 | 0.6 | 0.6 | 0.6 | 8.8 | 7.1 |

| | | | |
|---|---|---|---|
| t (mm) | 1.042 | 2.365 | 7.000 |
| n | 1.509 | 1.517 | 1.509 |

cos(A)=0.374

R1=160.791 mm

R2=−11.865 mm

|R1/R2|=13.551

Da (incident side)=0.47 mm, Db (incident side)=1.01 mm

Da (emission side)=0.92 mm, Db (emission side)=0.99 mm

Da/Db=0.93

The optical system for stereolithography apparatus according to Numerical Example 1 satisfies each conditional expression.

### Numerical Example 2

TABLE 2
f = 7.39 mm

| | Co-S1 | Co-S2 | Bs-S1 | Bs-S2 | CL-S1 | CL-S2 |
|---|---|---|---|---|---|---|
| r (mm) | 0.937 | −2.100 | −1.160 (y) | −1.961 (y) | 28.893 | −4.193 |
| k | −3.126E−01 | 3.816E+00 | — | — | 20.000 | −5.236 |
| A4 | 3.700E−01 | 5.104E−01 | — | — | 4.594E−03 | −9.204E−04 |
| A6 | −1.951E+00 | 5.407E−01 | — | — | −6.424E−04 | 9.694E−05 |
| A8 | 4.222E+00 | −2.670E+00 | — | — | 3.815E−05 | −2.046E−05 |
| A10 | −6.204E+00 | 3.835E+00 | — | — | −1.066E−06 | 1.479E−06 |
| A12 | 5.029E+00 | −2.649E+00 | — | — | 9.232E−09 | −4.958E−08 |
| A14 | −1.673E+00 | 9.316E−01 | — | — | 1.480E−10 | 8.049E−10 |
| A16 | — | — | — | — | −2.688E−12 | −5.183E−12 |
| ϕ (mm) | 0.6 | 0.6 | 0.6 | 0.6 | 5.6 | 5.6 |

| | | | |
|---|---|---|---|
| t (mm) | 1.042 | 2.365 | 5.389 |
| n | 1.509 | 1.517 | 1.509 |

cos(A)=0.622

R1=28.893 mm

R2=−4.193 mm

|R1/R2|=6.891

Da (incident side)=0.47 mm, Db (incident side)=1.01 mm

Da (emission side)=0.92 mm, Db (emission side)=0.99 mm

Da/Db=0.93

The optical system for stereolithography apparatus according to Numerical Example 2 satisfies each conditional expression.

### Numerical Example 3

TABLE 3
f = 5.70 mm

| | Co-S1 | Co-S2 | Bs-S1 | Bs-S2 | CL-S1 | CL-S2 |
|---|---|---|---|---|---|---|
| r (mm) | 0.937 | −2.100 | −1.160 (y) | −1.961 (y) | 27.801 | −3.112 |
| k | −3.126E−01 | 3.816E+00 | — | — | 20.000 | −4.479 |
| A4 | 3.700E−01 | 5.104E−01 | — | — | −1.881E−04 | −8.488E−03 |
| A6 | −1.951E+00 | 5.407E−01 | — | — | −4.522E−05 | 1.040E−03 |
| A8 | 4.222E+00 | −2.670E+00 | — | — | 4.318E−06 | −8.689E−05 |
| A10 | −6.204E+00 | 3.835E+00 | — | — | 3.597E−08 | 4.625E−06 |
| A12 | 5.029E+00 | −2.649E+00 | — | — | −1.474E−08 | −1.453E−07 |
| A14 | −1.673E+00 | 9.316E−01 | — | — | 5.313E−10 | 2.449E−09 |
| A16 | — | — | — | — | −6.063E−12 | −1.710E−11 |
| ϕ (mm) | 0.6 | 0.6 | 0.6 | 0.6 | 4.5 | 5.0 |

| | | | |
|---|---|---|---|
| t (mm) | 1.042 | 2.365 | 5.771 |
| n | 1.509 | 1.517 | 1.509 |

cos(A)=0.650

R1=27.801 mm

R2=−3.112 mm

|R1/R2|=8.933

Da (incident side)=0.47 mm, Db (incident side)=1.01 mm

Da (emission side)=0.92 mm, Db (emission side)=0.99 mm

Da/Db=0.93

The optical system for stereolithography apparatus according to Numerical Example 3 satisfies each conditional expression.

### Numerical Example 4

TABLE 4
f = 5.84 mm

| | Co-S1 | Co-S2 | Bs-S1 | Bs-S2 | CL-S1 | CL-S2 |
|---|---|---|---|---|---|---|
| r (mm) | 0.937 | −2.100 | −1.160 (y) | −1.961 (y) | 5.170 | −4.233 |
| k | −3.126E−01 | 3.816E+00 | — | — | −0.517 | −0.872 |
| A4 | 3.700E−01 | 5.104E−01 | — | — | −4.359E−05 | 8.151E−03 |
| A6 | −1.951E+00 | 5.407E−01 | — | — | −1.839E−04 | −1.333E−03 |
| A8 | 4.222E+00 | −2.670E+00 | — | — | 1.894E−05 | 1.516E−04 |
| A10 | −6.204E+00 | 3.835E+00 | — | — | −6.817E−07 | −7.846E−06 |
| A12 | 5.029E+00 | −2.649E+00 | — | — | −1.992E−08 | −1.905E−08 |
| A14 | −1.673E+00 | 9.316E−01 | — | — | 2.692E−09 | 2.311E−08 |
| A16 | — | — | — | — | −1.004E−10 | −1.156E−09 |
| A18 | — | — | — | — | 1.738E−12 | 2.450E−11 |
| A20 | — | — | — | — | −1.202E−14 | −1.983E−13 |
| ϕ (mm) | 0.6 | 0.6 | 0.6 | 0.6 | 5.7 | 5.2 |

| | | | |
|---|---|---|---|
| t (mm) | 1.042 | 2.365 | 6.008 |
| n | 1.509 | 1.517 | 1.509 |

cos(A)=0.541

R1=5.170 mm

R2=−4.233 mm

|R1/R2|=1.221

Da (incident side)=0.47 mm, Db (incident side)=1.01 mm

Da (emission side)=0.92 mm, Db (emission side)=0.99 mm

Da/Db=0.93

The optical system for stereolithography apparatus according to Numerical Example 4 satisfies each conditional expression.

Although the beam shaping unit in the present embodiment is configured using one cylindrical lens, the beam shaping unit may be configured using a diffractive optical element, not a cylindrical lens. Such a configuration allows reduction in the optical path length and it is thus possible to further miniaturize the optical system for stereolithography apparatus.

Where to mount the optical system for stereolithography apparatus according to the present embodiment is not limited to stereolithography apparatuses. The optical system for stereolithography apparatus according to the present invention is applicable to manufacturing machines, processing machines, measuring machines, and the like as long as their accuracy is influenced by the shape, the intensity, and the state of distribution of the radiated light.

Therefore, in the case of applying the optical system for stereolithography apparatus according to the above embodiment to a stereolithography apparatus, the stereolithography apparatus is capable of manufacturing with even higher resolution than before.

### INDUSTRIAL APPLICABILITY

The present invention is applicable as an optical system mounted on a stereolithography apparatus for high resolution manufacturing.

1. An optical system for stereolithography apparatus, comprising:
a light source;
an optical scanning section configured to reflect light emitted from the light source to scan to a manufacturing surface; and
a condenser lens arranged between the optical scanning section and the manufacturing surface and configured to condense the light reflected by the optical scanning section, wherein,
when the condenser lens has a focal length f and the condenser lens has a normal angle A at a maximum effective diameter on a surface on a side of the manufacturing surface, the optical system satisfies
f≤25 mm,
0.3<cos(A).

2. The optical system for stereolithography apparatus according to claim 1, wherein
the condenser lens is a biconvex lens, and,
when the condenser lens has a radius of curvature R1 on a surface on a side of the optical scanning section and the condenser lens and has a radius of curvature R2 on the surface on the side of the manufacturing surface, the optical system satisfies
1.0≤|R1/R2|.

3. The optical system for stereolithography apparatus according to claim 1, further comprising a beam shaping unit arranged between the light source and the optical scanning section, wherein,
when a light beam incident from the light source has a shorter axis on a cross section with a length Da and has a longer axis with a length Db, the beam shaping unit diffuses the light in a direction of the shorter axis to satisfy, on an emission side,
0.9<Da/Db<1.2.

4. The optical system for stereolithography apparatus according to claim 3, wherein the beam shaping unit has a concave surface formed along the longer axis on an incident side of the light beam emitted from the light source and also has a convex surface formed along the longer axis on the emission side.

5. The optical system for stereolithography apparatus according to claim 2, further comprising a beam shaping unit arranged between the light source and the optical scanning section, wherein,
when a light beam incident from the light source has a shorter axis on a cross section with a length Da and has a longer axis with a length Db, the beam shaping unit diffuses the light in a direction of the shorter axis to satisfy, on an emission side,
0.9<Da/Db<1.2.

6. The optical system for stereolithography apparatus according to claim 5, wherein the beam shaping unit has a concave surface formed along the longer axis on an incident side of the light beam emitted from the light source and also has a convex surface formed along the longer axis on the emission side.
